(19) United States
(12) Patent Application Publication
(10) Pub. No.: US 2015/0218494 A1
(43) Pub. Date: Aug. 6, 2015

(54) USE OF ACYLHYDRAZONE IN WASHING AND CLEANING AGENTS

(71) Applicant: Henkel AG & Co. KGaA, Duesseldorf (DE)

(72) Inventors: Andre Hatzelt, Duesseldorf (DE); Mirko Weide, Duesseldorf (DE)

(21) Appl. No.: 14/685,784

(22) Filed: Apr. 14, 2015

Related U.S. Application Data
(63) Continuation of application No. PCT/EP2013/068651, filed on Sep. 10, 2013.

(30) Foreign Application Priority Data
Oct. 23, 2012 (DE) 10 2012 219 359.6

(51) Int. Cl. C11D 3/395; C11D 3/30

(52) U.S. Cl. CPC C11D 3/3951; C11D 3/30; C11D 3/3953

(57) ABSTRACT

The intention was to improve the antimicrobial effectiveness of washing and cleaning agents. This was achieved substantially by the use a combination of peroxygen-containing bleaching agent with an acylhydrazone.

### FIELD OF THE INVENTION

The present invention generally relates to improving the antimicrobial effectiveness of washing and cleaning agents using a combination of bleaching agents with specific acylhydrazones.

### BACKGROUND OF THE INVENTION

Microorganisms such as bacteria, fungi, and viruses can become established on household surfaces and on textiles; bacteria and fungi can also reproduce on such surfaces. This can result in hygiene risks, but also in unaesthetic microbial deposits called “biofilms,” and in unpleasant odors.

At low temperature in particular, microorganisms are often not killed in the washing process, or at least removed from the textile, to a sufficient extent. This can result in the propagation of germs from one textile to another during the washing process, in particular when a bleach-free washing agent is used therein.

Hydrogen peroxide and in particular short-chain percarboxylic acids such as peracetic acid, which are released from bleach activators such as TAED in response to the perhydrolytic action of hydrogen peroxide, provide a certain degree of laundry hygiene via a washing process at temperatures above 40° C. At lower temperatures, however, their disinfecting action is appreciably limited.

Conventional bleach catalysts, for example MnTACN, exhibit no improvement in the hygiene performance of washing agents despite good bleaching performance at low temperatures.

International patent application WO 2009/124855 discloses metal complexes having acylhydrazone ligands which carry electron-withdrawing substituents in the vicinity of the acyl group.

It has been found, surprisingly, that when the combination of a peroxygen-containing bleaching agent with acylhydrazones is used, an appreciable intensification of the disinfecting action of washing and cleaning agents is obtained.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Use of a combination of peroxygen-containing bleaching agent with an acylhydrazone of the general formula (I)

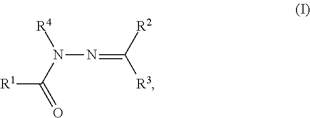

in which R¹ denotes a CF₃ group or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl, or C₃₋₁₂ cycloheteroalkyl group; R² and R³ mutually independently denote hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, or heteroaryl group, or R2 and R3, together with the carbon atom connecting them, denote an optionally substituted 5-, 6-, 7-, 8-, or 9-membered ring that can optionally contain heteroatoms; and R⁴ denotes hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, or an optionally substituted phenyl or naphthyl or heteroaryl group, to improve the antimicrobial effectiveness of washing and cleaning agents.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The subject of the invention is the use of a combination of peroxygen-containing bleaching agent with an acylhydrazone of the general formula (I)

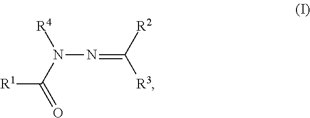

in which R¹ denotes a CF₃ group or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl, or C₃₋₁₂ cycloheteroalkyl group,
R² and R³ mutually independently denote hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, or heteroaryl group, or R2 and R3, together with the carbon atom connecting them, denote an optionally substituted 5-, 6-, 7-, 8-, or 9-membered ring that can optionally contain heteroatoms, and R⁴ denotes hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, or an optionally substituted phenyl or naphthyl or heteroaryl group,
to improve the antimicrobial effectiveness of washing and cleaning agents.

The acylhydrazones can be present in an E- or Z-configuration; if R² is hydrogen, the compound of the general formula (I) can be present in its tautomeric forms or as a mixture thereof.

In compounds of the general formula (I), R² is preferably hydrogen. R¹ and/or R³ is preferably a methyl, phenyl, or naphthyl group substituted with an electron-withdrawing group. R⁴ is preferably hydrogen. A suitable electron-withdrawing group is preferably an ammonium group, which optionally carries alkyl or hydroxyalkyl groups or is embodied, with inclusion of the nitrogen atom carrying an alkyl group, as a heterocycloalkyl group optionally carrying further heteroatoms.

Preferred embodiments of the compounds according to the general formula (I) including those of the general formula (II)

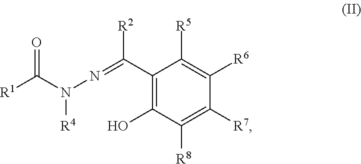

in which R¹ denotes a C₁₋₄ alkyl group that carries a substituent

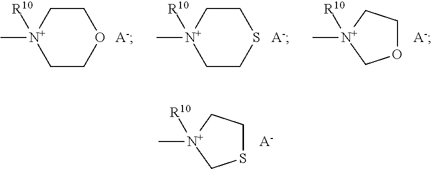

in which R¹⁰ denotes hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, and A⁻ denotes the anion of an organic or inorganic acid,
R² and R⁴ have the meaning indicated for formula (I), and
R⁵, R⁶, R⁷, and R⁸ mutually independently denote R¹, hydrogen, halogen, a hydroxy, amino, optionally substituted N-mono- or -di-C₁₋₄ alkylamino or —C₂₋₄ hydroxyalkylamino, N-phenylamino or N-naphthylamino, C₁₋₂₈ alkyl, C₁₋₂₈ alkoxy, phenoxy, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, phenyl, or naphthyl group, wherein the substituents are selected from C₁₋₄ alkyl, C₁₋₄ alkoxy, hydroxy, sulfo, sulfato, halogen, cyano, nitro, carboxy, phenyl, phenoxy, naphthoxy, amino, N-mono- or -di-C₁₋₄ alkylamino or —C₂₋₄ hydroxyalkylamino, N-phenylamino, or N-naphthylamino groups, or
R⁵ and R⁶ or R⁶ and R⁷ or R⁷ and R⁸ are connected to one another forming one, two, or three carbocyclic or O-, NR¹⁰-, or S-heterocyclic, optionally aromatic and/or optionally C₁₋₆ alkyl-substituted rings.

The anion A⁻ is preferably a carboxylate such as lactate, citrate, tartrate or succinate, perchlorate, tetrafluoroborate, hexafluorophosphate, alkylsulfonate, alkyl sulfate, hydrogen sulfate, sulfate, dihydrogen phosphate, hydrogen phosphate, isocyanate, rhodanide, nitrate, fluoride, chloride, bromide, hydrogen carbonate, or carbonate, wherein in the case of polyvalent anions, charge compensation can be achieved by the presence of additional cations such as sodium ions or ammonium ions.

The acylhydrazone of formula

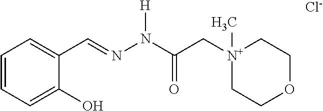 [SMILES: C[N+]1(CC(=O)N/N=C/c2ccccc2O)CCOCC1 ; [Cl-]]

is particularly preferred.

The compounds of the general formula (I) intensify the disinfecting action of peroxygen compounds without unacceptable oxidative damage to the textile to be cleaned. Utilization of the combination essential to the invention results in improved germ removal, in particular with respect to bacteria, fungi, yeasts, and bacterial spores, as well as parasites, mites, and algae, in particular at low washing temperatures below 60° C., for example 40° C., and even at room temperature.

The peroxygen compounds used are preferably H₂O₂ or substances that release H₂O₂ in water, included among which are especially alkali perborates, alkali percarbonates, and urea perhydrate; it is also possible, however, to use peroxocarboxylic acids such as diperoxodecanedicarboxylic acid or phthalimidopercapronic acid, other peroxo acids or peroxo acid salts such as alkali persulfates or alkali peroxodisulfates, or caroates, or diacyl peroxides or tetraacyl peroxides.

The performance of compounds of the general formula (I) can optionally be further intensified by the presence of ions of manganese, of titanium, of cobalt, of nickel, or of copper, preferably Mn(II)-(III)-(IV)-(V), Cu(I)-(II)-(III), Fe-(I)-(II)-(III)-(IV), Co(I)-(II)-(III), Ni(I)-(II)-(III), Ti(II)-(III)-(IV), and particularly preferably those selected from Mn(II)-(III)-(IV)-(V), Cu(I)-(II)-(III), Fe-(I)-(II)-(III)-(IV), and Co(I)-(II)-(III); if desired, the acylhydrazone can also be used in the form of complex compounds of the aforesaid central metal atoms with ligands of the general formula (I) and in particular of the general formula (II).

A disinfection-intensifying complex that comprises a ligand having a backbone according to formula (I) can comprise the corresponding ligands once or also repeatedly, in particular twice. It can be mononuclear or optionally binuclear or polynuclear. It can furthermore comprise further neutral, anionic, or cationic ligands, for example H₂O, NH₃, CH₃OH, acetylacetone, terpyridine, organic anions such as citrate, oxalate, tartrate, formate, a C₂₋₁₈ carboxylate, a C₁₋₁₈ alkyl sulfate, in particular methosulfate, or a corresponding alkanesulfonate, inorganic anions, for example halide, in particular chloride, perchlorate, tetrafluoroborate, hexafluorophosphate, nitrate, hydrogen sulfate, hydroxide, or hydroperoxide. It can also comprise bridging ligands, for example alkylenediamines.

In the context of the use according to the present invention it is preferred if the concentration of the compound according to formula (I) in the aqueous washing bath, for example as utilized in washing machines, is 0.5 μmol/l to 500 μmol/l, in particular 5 μmol/l to 100 μmol/l. The concentration of ions of manganese, of titanium, of cobalt, of nickel, and/or of copper in the aqueous washing bath is preferably in the range from 0.05 μmol/l to 500 μmol/l, in particular 1 μmol/l to 100 μmol/l. Preferred peroxygen concentrations (calculated as H₂O₂) in the washing bath are in the range from 0.001 g/l to 10 g/l, in particular fro 0.1 g/l to 1 g/l, and particularly preferably from 0.2 g/l to 0.5 g/l. The use according to the present invention is preferably carried out at temperatures in the range from 10° C. to 95° C., in particular 20° C. to 40° C., and particularly preferably at temperatures below 30° C. The water hardness of the water utilized to prepare the aqueous washing bath is preferably in the range from 0° dH to 21° dH, in particular 0° dH to 3° dH. The water hardness in the washing bath is preferably in the range from 0° dH to 16° dH, in particular 0° dH to 3° dH, which can be achieved e.g. by the use of usual builder materials or water softeners. The use according to the present invention is preferably carried out at pH values in the range from pH 5 to pH 12, in particular from pH 7 to pH 11.

The use according to the present invention preferably occurs in such a way that a washing agent that contains an acylhydrazone of the general formula (I) is allowed to act on a soiled textile in the context of an automatic washing operation or one performed by hand. The use according to the present invention can be implemented particularly simply by using, in order to launder textiles that require cleaning, a washing agent that contains a peroxygen compound and a compound of formula (I) or a bleach catalyst accessible therefrom by complexing with an aforesaid transition metal ion. Alternatively, the peroxygen compound and/or the compound of formula (I) and/or a complex accessible therefrom can also be added separately to a washing bath that comprises a washing agent not having the respectively recited ingredient.

Preferably 0.01 wt % to 5 wt %, in particular 0.05 wt % to 0.2 wt %, and particularly preferably 0.03 wt % to 0.09 wt % of the compound according to formula (I) is contained in washing agents. In particular when a compound of formula (I) is contained, it is preferred that the agent additionally contain a manganese, titanium, cobalt, nickel, or copper salt and/or a manganese, titanium, cobalt, nickel, or copper complex not having a ligand that corresponds to a compound according to formula (I). The molar ratio of the aforesaid transition metal or of the sum of the aforesaid transition metals to the compound according to formula (I) is then preferably in the range from 0.001:1 to 2:1, in particular 0.01:1 to 1:1. In a further preferred embodiment of the agents, 0.05 wt % to 1 wt %, in particular 0.1 wt % to 0.5 wt %, of disinfection-intensifying complex that comprises a ligand according to formula (I) is contained in said agents. A preferred transition metal is Mn.

Peroxygen compounds that are suitable for being contained in the agents are, in particular, organic peracids or peracidic salts of organic acids such as phthalimidopercapronic acid, perbenzoic acid or salts of diperdodecanedioic acid, hydrogen peroxide and inorganic salts that release hydrogen peroxide under washing conditions, such as perborate, percarbonate, and/or persilicate. Hydrogen peroxide can also be generated with the aid of an enzymatic system, i.e. an oxidase and its substrate. If solid peroxygen compounds are to be used, they can be utilized in the form of powders or granulates that in principle can also be encased in known fashion. It is particularly preferred to use alkali percarbonate, alkali perborate monohydrate, alkali perborate tetrahydrate, or hydrogen peroxide in the form of aqueous solutions that contain 3 wt % to 10 wt % hydrogen peroxide. Peroxygen compounds are present in washing agents preferably in quantities of up to 50 wt %, in particular from 1 wt % to 20 wt %, and particularly preferably from 7 wt % to 15 wt %.

In a further preferred embodiment of the invention, in particular when a peroxygen compound releasing H₂O₂ is present, a usual bleach activator is used together with the acylhydrazone of the general formula (I) and in particular of the general formula (II). Bleach activators are contained in washing agents preferably in quantities from 0.1 wt % to 10 wt %, in particular from 1 wt % to 3 wt %, based in each case on the total agent. It is preferred to use a compound forming peroxocarboxylic acid under perhydrolysis conditions and acylhydrazone at molar ratios in the range from 4:1 to 100:1, in particular from 25:1 to 50:1.

Compounds that, under perhydrolysis conditions, yield optionally substituted perbenzoic acid and/or aliphatic peroxocarboxylic acids having 1 to 12 carbon atoms, in particular 2 to 4 carbon atoms can be used, alone or in mixtures, as a compound supplying peroxocarboxylic acid under perhydrolysis conditions. Bleach activators that carry O- and/or N-acyl groups in particular having the aforesaid number of carbon atoms, and/or optionally substituted benzoyl groups, are suitable. Polyacylated alkylenediamines, in particular tetraacetylethylendiamine (TAED), acylated glycolurils, in particular tetraacetyl glycoluril (TAGU), acylated triazine derivatives, in particular 1,5-diacetyl-2,4-dioxohexahydro-1,3,5-triazine (DADHT), N-acylimides, in particular N-nonanoyl succinimide (NOSI), acylated phenolsulfonates or -carboxylates or the sulfonic acids or carboxylic acids thereof, in particular nonanoyl or isononanoyl or lauryl oxybenzenesulfonate (NOBS or iso-NOBS or LOBS), or decanoyloxybenzoate (DOBA), formal carbonic acid ester derivatives thereof such as 4-(2-decanoyloxyethoxycarbonyloxyl)benzenesulfonate (DECOBS), acylated polyvalent alcohols, in particular triacetin, ethylene glycol diacetate, 2,5-diacetoxy-2,5-dihydrofuran, as well as acetylated sorbitol and mannitol and mixtures thereof (SORMAN), acylated sugar derivatives, in particular pentaacetylglucose (PAG), pentaacetylfructose, tetraacetylxylose and octaacetyllactose, acetylated, optionally N-alkylated glucamine and gluconolactone, and/or N-acylated lactams, for example N-benzoylcaprolactam, are preferred.

Additionally or alternatively to the compounds that form peroxocarboxylic acids under perhydrolysis conditions, further bleach-activating compounds such as nitriles, from which perimidic acids form under perhydrolysis conditions, can be present. These include, in particular, aminoacetonitrile derivatives having a quaternized nitrogen atom, according to the formula

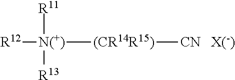

in which R¹¹ denotes —H, —CH₃, a C₂₋₂₄ alkyl or alkenyl residue, a substituted C₁₋₂₄ alkyl or C₂₋₂₄ alkenyl residue having at least one substituent from the group —Cl, —Br, —OH, —NH₂, —CN, and —N⁽⁺⁾—CH₂—CN, an alkyl or alkenylaryl residue having a C₁₋₂₄ alkyl group, or a substituted alkyl or alkenylaryl residue having at least one, preferably two optionally substituted C₁₋₂₄ alkyl groups and optionally further substituents on the aromatic ring, R¹² and R¹³ are mutually independently selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH where n=1, 2, 3, 4, 5 or 6, R¹⁴ and R¹⁵ mutually independently have a meaning indicated above for R¹¹, R¹², or R¹³, wherein at least two of the aforesaid residues, in particular R¹² and R¹³, can also be linked to one another by ring closing with inclusion of the nitrogen atom and optionally of further heteroatoms, and then preferably form a morpholino ring, and X is a charge-compensating anion, preferably selected from benzenesulfonate, toluenesulfonate, cumolsulfonate, C₉₋₁₅ alkylbenzenesulfonates, C₁₋₂₀ alkyl sulfates, C₈₋₂₂ carboxylic acid methyl ester sulfonates, sulfate, hydrogen sulfate, and mixtures thereof, and mixtures thereof, can be used. Oxygen-transferring sulfonimines can also be used.

To avoid interaction with the peroxygen compounds during storage, the bleach activators can in known fashion be coated with enveloping substances or granulated; tetraacetylethylenediamine granulated with carboxymethyl cellulose and having average particle sizes from 0.01 mm to 0.8 mm, granulated 1,5-diacetyl-2,4-dioxohexahydro-1,3,5-triazine, and/or trialkylammonium acetonitrile prepared in particle form are particularly preferred.

In addition to the combination to be used according to the present invention, usual transition metal complexes that activate the bleach can also be used. These are preferably selected from among complexes of cobalt, of iron, of copper, of titanium, of vanadium, of manganese, and of ruthenium. Suitable ligands in such transition metal complexes are both inorganic and organic compounds, among which are included, besides carboxylates, in particular compounds having primary, secondary, and/or tertiary amine and/or alcohol functions, such as pyridine, pyridazine, pyrimidine, pyrazine, imidazole, pyrazole, triazole, 2,2′-bispyridylamine, tris-(2-pyridylmethyl)amine, 1,4,7-triazacyclononane and substituted derivatives thereof such as 1,4,7-trimethyl-1,4,7-triazacyclononane, 1,5,9-triazacyclododecane and substituted derivatives thereof such as 1,5,9-trimethyl-1,5,9-triazacyclododecane, 1,4,8,11-tetraazacyclotetradecane and substituted derivatives thereof such as 5,5,7,12,12,14-hexamethyl-1,4,8,11-tetraazacyclotetradecane, 1,5,8,12-tetraazabicyclo[6.6.2]hexadecane and substituted derivatives thereof such as 5,12-diethyl-1,5,8,12-tetraazabicyclo[6.6.2]hexadecane, (bis-((1-methylimidazol-2-yl)methyl))-(2-pyridylmethyl)amine, N,N′-(bis-(1-methylimidazol-2-yl)methyl)ethylenediamine, N-bis-(2-benzimidazolylmethyl)aminoethanol, 2,6-bis-(bis-(2-benzimidazolylmethyl)aminomethyl)-4-methylphenol, N,N,N′,N′-tetrakis-(2-benzimidazolylmethyl)-2-hydroxy-1,3-diaminopropane, 2,6-bis-(bis-(2-pyridylmethyl)aminomethyl)-4-methylphenol, 1,3-bis-(bis-(2-benzimidazolylmethyl)aminomethyl)benzene, sorbitol, mannitol, erythritol, adonitol, inositol, lactose, and optionally substituted salens, porphins, and porphyrins. The inorganic neutral ligands include in particular ammonia and water. If not all the coordination sites of the central transition metal atom are occupied by neutral ligands, the complex contains further, preferably anionic, and among the latter in particular unidentate or bidentate ligands. These include in particular halides such as fluoride, chloride, bromide, and iodide, and the (NO₂)⁻ group, i.e. a nitro ligand or a nitrilo ligand. The (NO₂)⁻ group can also be bound to a transition metal to form a chelate, or it can bridge two transition metal atoms asymmetrically or in η¹-O fashion. Aside from the ligands recited, the transition metal complexes can also carry further ligands, as a rule of simpler construction, in particular mono- or polyvalent anionic ligands. Nitrate, acetate, trifluoracetate, formate, carbonate, citrate, oxalate, perchlorate, and complex anions such hexafluorophosphate are, for example, appropriate. The anionic ligands are intended to provide charge compensation between the central transition metal atom and the ligand system. The presence of oxo ligands, peroxo ligands, and imino ligands is also possible. Such ligands in particular can also act in bridging fashion, so that polynuclear complexes are produced. In the case of bridged binuclear complexes, the two metal atoms in the complex do not need to be the same. The use of binuclear complexes, in which the two central transition metal atoms have different oxidation numbers, is also possible. If anionic ligands are absent, or if the presence of anionic ligands does not result in charge compensation in the complex, anionic counter ions that neutralize the cationic transition metal complex are then present in the transition metal complex compounds to be used in accordance with the invention. These anionic counter ions include, in particular, nitrate, hydroxide, hexafluorophosphate, sulfate, chlorate, perchlorate, halides such as chloride, or anions of carboxylic acids such as formate, acetate, oxalate, benzoate, or citrate. Examples of usable transition metal complex compounds are Mn(IV)₂(μ-O)₃(1,4,7-trimethyl-1,4,7-triazacyclononane)dihexafluorophosphate, [N,N′-bis[(2-hydroxy-5-vinylphenyl)methylene-1,2-diaminocyclohexane]manganese(lll) chloride, [N,N′-bis[(2-hydroxy-5-nitrophenyl)methylene]-1,2-diaminocyclohexane]manganese(lll) acetate, [N,N′-bis[(2-hydroxyphenyl)methylene]-1,2-phenylenediamine]manganese(lll) acetate, [(2-hydroxyphenyl)methylene]-1,2-diaminocyclohexane]manganese(lll) chloride, [N,N′-bis[(2-hydroxyphenyl)methylene]-1,2-diaminoethane]manganese(lll) chloride, [N,N′-bis[(2-hydroxy-5-sulfonatophenyemethylene]-1,2-diaminoethane]manganese(III) chloride, manganese-oxalato complexes, nitropentamminecobalt(lll) chloride, nitritopentamminecobalt(lll) chloride, hexamminecobalt(lll) chloride, chloropentamminecobalt(lll) chloride, and the peroxo complex [(NH₃)₅Co—O—O—Co(NH₃)₅]CI₄.

Washing agents, which can be present as, in particular, powdered solids, in recompressed tablet form, as homogeneous solutions, or as suspensions, can in principle contain, in addition to the combination to be used according to the present invention of a peroxygen compound and a compound according to formula (I), as well as the aforesaid bleach activators and bleach catalysts, all known ingredients that are usual in such agents. The agents can in particular contain builder substances, surface-active surfactants, water-miscible organic solvents, enzymes, sequestration agents, electrolytes, pH regulators, polymers having special effects, such as soil-release polymers, color transfer inhibitors, anti-gray agents, wrinkle-reducing polymeric active agents and shape-retaining polymeric active agents, and further adjuvants such as optical brighteners, foam regulators, dyes, and scents.

To further intensify the disinfecting action, for example with respect to specific germs, an agent can additionally contain usual antimicrobial active agents, for example alcohols, aldehydes, acids, carboxylic acid esters, acid amides, phenols and phenol derivatives, diphenyls, diphenylalkanes, urea derivatives, O-acetates and O-formals bound to organic backbones, benzamidines, isothiazolines, phthalimide derivatives, pyridine derivatives, amines, quaternary ammonium compounds, guanidines, amphoteric compounds, quinolines, benzimidazoles, IPBC, dithiocarbamates, metals and metal compounds, for example silver and silver salts, halogens, for example chlorine, iodine, and compounds thereof, further oxidizing agents, and inorganic nitrogen compounds. Antimicrobial additives of this kind are contained preferably in quantities of up to 10 wt %, in particular from 0.01 wt % to 5 wt %, based in each case on the total agent; in a preferred embodiment, however, they are free of such additional disinfectant active agents.

The agents can contain one or more surfactants; anionic surfactants, nonionic surfactants, and mixtures thereof are especially appropriate, but cationic and/or amphoteric surfactants can also be contained. Suitable nonionic surfactants are, in particular, alkyl glycosides and ethoxylation and/or propoxylation products of alkyl glycosides, or linear or branched alcohols each having 12 to 18 carbon atoms in the alkyl portion and 3 to 20, preferably 4 to 10, alkyl ether groups. Also usable are corresponding ethoxylation and/or propoxylation products of N-alkylamines, vicinal diols, fatty acid esters and fatty acid amides that correspond in terms of the alkyl portion to the aforesaid long-chain alcohol derivatives, and of alkylphenols having 5 to 12 carbon atoms in the alkyl residue.

Suitable anionic surfactants are in particular soaps, and those which contain sulfate or sulfonate groups having preferably alkali ions as cations. Usable soaps are preferably the alkali salts of saturated or unsaturated fatty acids having 12 to 18 carbon atoms. Such fatty acids can also be used in incompletely neutralized form. Included among the usable surfactants of the sulfate type are the salts of sulfuric acid semiesters of fatty alcohols having 12 to 18 carbon atoms, and sulfatization products of the aforesaid nonionic surfactants having a low degree of ethoxylation. Included among the usable surfactants of the sulfonate type are linear alkylbenzenesulfonates having 9 to 14 carbon atoms in the alkyl portion, alkanesulfonates having 12 to 18 carbon atoms, and olefinsulfonates having 12 to 18 carbon atoms that are produced upon reaction of corresponding monoolefins with sulfur trioxide, as well as alpha-sulfofatty acid esters that are produced upon sulfonation of fatty acid methyl or ethyl esters.

Surfactants of this kind are contained in washing agents in quantitative proportions from preferably 5 wt % to 50 wt %, in particular from 8 wt % to 30 wt %.

A washing agent preferably contains at least one water-soluble and/or water-insoluble organic and/or inorganic builder. Included among the water-soluble organic builder substances are polycarboxylic acids, in particular citric acid and sugar acids, monomeric and polymeric aminopolycarboxylic acids, in particular glycinediacetic acid, methylglycinediacetic acid, nitrilotriacetic acid, iminodisuccinates such as ethylenediamine-N,N′-disuccinic acid and hydroxyiminodisuccinates, ethylenediaminetetraacetic acid, as well as polyaspartic acid, polyphosphonic acids, in particular aminotris(methylenephosphonic acid), ethylenediaminetetrakis(methylenephosphonic acid), lysinetetra(methylenephosphonic acid), and 1-hydroxyethane-1,1-diphosphonic acid, polymeric hydroxy compounds such as dextrin, and polymeric (poly)carboxylic acids, in particular polycarboxylates accessible by the oxidation of polysaccharides or dextrins, polymeric acrylic acids, methacrylic acids, maleic acids and mixed polymers thereof, which can also contain, polymerized into them, small proportions of polymerizable substances having no carboxylic-acid functionality. The relative molecular weight (here and hereinafter: weight-average) of the homopolymers of unsaturated carboxylic acids is generally between 5000 g/mol and 200,000 g/mol, that of the copolymers between 2000 g/mol and 200,000 g/mol, preferably 50,000 g/mol to 120,000 g/mol, based in each case on free acid. A particularly preferred acrylic acid/maleic acid copolymer has a relative average molecular weight from 50,000 to 100,000. Suitable although less preferred compounds of this class are copolymers of acrylic acid or methacrylic acid with vinyl ethers such as vinyl methyl ethers, vinyl esters, ethylene, propylene, and styrene, in which the proportion of acid is equal to at least 50 wt %. It is also possible to use, as water-soluble organic builder substances, terpolymers that contain two unsaturated acids and/or salts thereof as monomers and, as a third monomer, vinyl alcohol and/or a vinyl alcohol derivative or a carbohydrate. The first acidic monomer or salt thereof is derived from an ethylenically monounsaturated C₃ to C₈ carboxylic acid and preferably from a C₃ to C₄ monocarboxylic acid, in particular from (meth)acrylic acid. The second acidic monomer or salt thereof can be a derivative of a C₄ to C₈ dicarboxylic acid, maleic acid being particularly preferred. The third monomeric unit is constituted in this case by vinyl alcohol and/or preferably by an esterified vinyl alcohol. Vinyl alcohol derivatives that represent an ester of short-chain carboxylic acids, for example of C₁ to C₄ carboxylic acids, with vinyl alcohol, are particularly preferred. Preferred polymers contain 60 wt % to 95 wt %, in particular 70 wt % to 90 wt % (meth)acrylic acid or (meth)acrylate, particularly preferably acrylic acid or acrylate, and maleic acid or maleinate, as well as 5 wt % to 40 wt %, preferably 10 wt % to 30 wt % vinyl alcohol and/or vinyl acetate. Very particularly preferred in this context are polymers in which the weight ratio of (meth)acrylic acid or (meth)acrylate to maleic acid or maleinate is between 1:1 and 4:1, preferably between 2:1 and 3:1, and in particular 2:1 and 2.5:1. Both the quantities and the weight ratios are based on the acids. The second acidic monomer or salt thereof can also be a derivative of an allylsulfonic acid that is substituted in the 2-position with an alkyl residue, preferably with a C₁ to C₄ alkyl residue, or with an aromatic residue that is derived preferably from benzene or benzene derivatives. Preferred terpolymers contain 40 wt % to 60 wt %, in particular 45 to 55 wt % (meth)acrylic acid or (meth)acrylate, particularly preferably acrylic acid or acrylate, 10 wt % to 30 wt %, preferably 15 wt % to 25 wt % methallylsulfonic acid or methallylsulfonate, and as a third monomer 15 wt % to 40 wt %, preferably 20 wt % to 40 wt % of a carbohydrate. This carbohydrate can be, for example, a mono-, di-, oligo-, or polysaccharide, mono-, di-, or oligosaccharides being preferred. Sucrose is particularly preferred. The use of the third monomer is presumed to incorporate defined break points into the polymer, which are responsible for the polymer's good biodegradability. These terpolymers generally have a relative molecular weight between 1000 g/mol and 200,000 g/mol, preferably between 200 g/mol and 50,000 g/mol. Further preferred copolymers are those which comprise acrolein and acrylic acid/acrylic acid salts or vinyl acetate as monomers. Especially for the manufacture of liquid agents, the organic builder substances can be used in the form of aqueous solutions, preferably in the form of 30- to 50-weight-percent aqueous solutions. All the aforesaid acids are used as a rule in the form of water-soluble salts thereof, in particular alkali salts thereof.

Organic builder substances of this kind can be contained, if desired, in quantities of up to 40 wt %, in particular up to 25 wt %, and preferably from 1 wt % to 8 wt %. Quantities close to the aforesaid upper limit are used preferably in pasty or liquid, in particular hydrous agents.

Possibilities as water-soluble inorganic builder materials are, in particular, polyphosphates, preferably sodium triphosphate. Crystalline or amorphous water-dispersible alkali aluminosilicates are used in particular as water-insoluble, water-dispersible inorganic builder materials, in quantities not above 25 wt %, preferably from 3 wt % to 20 wt %, and in particular in quantities from 5 wt % to 15 wt %. Among these, the crystalline sodium aluminosilicates of washing-agent quality, in particular zeolite A, zeolite P, and zeolite MAP, are preferred. Quantities close to the aforesaid upper limit are preferably used in solid, particulate agents. Suitable aluminosilicates comprise, in particular, no particles having a particle size greater than 30 μm, and preferably are made up at a proportion of at least 80 wt % of particles having a size less than 10 μm. Their calcium binding capability is generally in the range from 100 to 200 mg CaO per gram.

Additionally or alternatively to the aforesaid water-insoluble aluminosilicate and alkali carbonate, further water-soluble inorganic builder materials can be contained. These include, besides polyphosphates such as sodium triphosphate, in particular water-soluble crystalline and/or amorphous alkali silicate builders. Water-soluble inorganic builder materials of this kind are contained in the agents preferably in quantities from 1 wt % to 20 wt %, in particular from 5 wt % to 15 wt %. Alkali silicates usable as builder materials preferably have a molar ratio of alkali oxide to SiO₂ below 0.95, in particular from 1:1.1 to 1:12, and can be present in amorphous or crystalline form. Preferred alkali silicates are sodium silicates, in particular amorphous sodium silicates, having a Na₂O:SiO₂ molar ratio from 1:2 to 1:2.8. Crystalline sheet silicates of the general formula Na₂SiₓO₂ₓ₊₁.yH₂O, in which x, the so-called modulus, is a number from 1.9 to 4 and y is a number from 0 to 20, and preferred values for x are 2, 3 or 4, are preferred for use as crystalline silicates, which can be present alone or mixed with amorphous silicates. Preferred crystalline sheet silicates are those in which x in the aforesaid general formula assumes the values 2 or 3. Both β- and δ-sodium disilicates (Na₂Si₂O₅.yH₂O) are particularly preferred. Practically anhydrous crystalline alkali silicates manufactured from amorphous alkali silicates and having the aforesaid general formula, in which x denotes a number from 1.9 to 2.1, can be used in the agents. In a further preferred embodiment a crystalline sodium sheet-form silicate having a modulus from 2 to 3 can be used, such as the one that can be manufactured from sand and soda. Sodium silicates having a modulus in the range from 1.9 to 3.5 are used in a further preferred embodiment. In a preferred embodiment of such agents, a granular compound of alkali silicate and alkali carbonate is used, for example as obtainable commercially under the name Nabion® 15.

Appropriate enzymes that are optionally contained in the washing agents are in particular those from the class of proteases, lipases, cutinases, amylases, pullulanases, xylanases, hemicellulases, cellulases, peroxidases, and oxidases, or mixtures thereof; the use of protease, amylase, lipase, and/or cellulase is particularly preferred. The proportion is preferably 0.2 wt % to 1.5 wt %, in particular 0.5 wt % to 1 wt %. The enzymes can, in usual fashion, be adsorbed onto carrier substances and/or embedded into encasing substances, or can be incorporated as concentrated liquid formulations containing as little water as possible.

Suitable anti-gray agents or soil-release active agents are cellulose ethers such carboxymethyl cellulose, methyl cellulose, hydroxyalkyl celluloses, and cellulose mixed ethers such as methylhydroxyethyl cellulose, methylhydroxypropyl cellulose, and methylcarboxymethyl cellulose. Sodium carboxymethyl cellulose and mixtures thereof with methyl cellulose are preferably used. Included among the soil-release active agents usually used are copolyesters that contain dicarboxylic acid units, alkylene glycol units, and polyalkylene glycol units. The concentration in the agents of anti-gray agents and/or soil-release active agents is generally not above 2 wt % and is preferably 0.5 wt % to 1.5 wt %.

Derivatives of diaminostilbenedisulfonic acid or alkali metal salts thereof can be contained, for example, in washing agents as optical brighteners in particular for textiles made of cellulose fibers (e.g. cotton). Suitable, for example, are salts of 4,4′-bis(2-anilino-4-morpholino-1,3,5-triazin-6-yl-amino)stilbene-2,2′-disulfonic acid or compounds of similar structure that carry, instead of the morpholino group, a diethanolamino group, a methylamino group, or a 2-methoxyethylamino group. Brighteners of the substituted 4,4′-diphenylstyryl type can also be present, e.g. 4,4′-bis(4-chloro-3-sulfostyryl)diphenyl. Mixtures of optical brighteners can also be used. Brighteners of the 1,3-diaryl-2-pyrazoline type, for example 1-(p-sulfoamoylphenyl)-3-(p-chlorophenyl)-2-pyrazoline, as well as compounds of similar structure, are particularly suitable for polyamide fibers. The concentration of optical brighteners or brightener mixtures in the agent is generally not above 1 wt %, and preferably in the range from 0.05 wt % to 0.5 wt %.

Among the usual foam regulators usable in washing agents are, for example polysiloxane/silicic acid mixtures, the finely particulate silicic acid contained therein preferably being silanated or otherwise hydrophobized. The polysiloxanes can be made up of both linear compounds and crosslinked polysiloxane resins, as well as mixtures thereof. Further defoamers are paraffin hydrocarbons, in particular microparaffins and paraffin waxes whose melting point is above 40° C., saturated fatty acids or soaps having in particular 20 to 22 carbon atoms, for example sodium behenate, and alkali salts of phosphoric acid mono- and/or dialkyl esters in which the alkyl chains each comprise 12 to 22 carbon atoms. Among these it is preferred to use sodium monoalkyl and/or dialkyl phosphate having C₁₆ to C₁₈ alkyl groups. The proportion of foam regulators can preferably be 0.2 wt % to 2 wt %.

The agents can contain water as a solvent. Included among the organic solvents that are usable in the agents, especially when the latter exist in liquid or pasty form, are alcohols having 1 to 4 carbon atoms, in particular methanol, ethanol, isopropanol and tert-butanol, diols having 2 to 4 carbon atoms, in particular ethylene glycol and propylene glycol and mixtures thereof, and ethers derivable from the aforesaid compound classes. Water-miscible solvents of this kind are present in the agents in quantities preferably not above 20 wt %, in particular from 1 wt % to 15 wt %.

In order to establish a desired pH that does not result spontaneously from mixture of the other components, the agents can contain system-compatible and environmentally compatible acids, in particular citric acid, acetic acid, tartaric acid, malic acid, lactic acid, glycolic acid, succinic acid, glutaric acid and/or adipic acid, but also mineral acids, in particular sulfuric acid, or alkali hydrogen sulfate or bases, in particular ammonium hydroxides or alkali hydroxides. pH regulators of this kind are contained in the agents in quantities preferably not above 10 wt %, in particular from 0.5 wt % to 6 wt %.

The manufacture of solid agents presents no difficulties and can in principle be accomplished in a known manner, for example by spray drying or granulation, thermally sensitive ingredients optionally being added separately later.

Agents in the form of aqueous solutions or solutions containing other usual solvents are manufactured particularly advantageously by simply mixing the ingredients, which can be introduced into an automatic mixer as substance or in solution.

The agents are present preferably as powdered, granular, or tablet-shaped preparations that can be manufactured in a known manner, for example by mixing, granulating, roller-compacting, and/or spray drying of the thermally robust components and mixing in the more sensitive components, which include in particular enzymes, bleaching agents, and bleach-activating active agents. A method comprising an extrusion step is preferred for the manufacture of agents having an elevated bulk weight, in particular in the range from 650 g/l to 950 g/l.

The procedure for manufacturing agents in tablet form is preferably such that all the constituents are mixed with one another in a mixer and the mixture is compressed using conventional tablet presses, for example eccentric presses or rotary presses, at compression pressures in the range from 200·10⁵ Pa to 1500·10⁵ Pa. Break-resistant tablets that are nevertheless sufficiently rapidly soluble under the utilization conditions, having fracture strength values normally above 150 N, are thereby obtained without difficulty. A tablet manufactured in this fashion preferably has a weight from 15 g to 40 g, in particular from 20 g to 30 g, with a diameter from 35 mm to 40 mm.

### Examples

The antibacterial effectiveness of a solution (V1) containing 3.77 g/l of a bleaching-agent-free, bleach-activator-free, and biocide-free washing agent, of a solution (V2) of otherwise identical composition that additionally contained 1.76 g/l (calculated as 100% substance) sodium percarbonate, of a solution (V3) otherwise identical in composition to V2 that additionally contained 0.49 g/l TAED, and of two solutions otherwise identical in composition to V3 which additionally contained 0.024 g/l (E1) or 0.007 g/l (E2) morpholinium-4-(2-(2-((2-hydroxyphenylmethyl)methylene)hydrazinyl)-2-oxoethyl)-4-methyl chloride, as well as a solution (V4) of composition otherwise identical to V1 which additionally contained 0.024 g/l morpholinium-4-(2-(2-((2-hydroxyphenylmethyl)methylene)hydrazinyl)-2-oxoethyl)-4-methyl chloride, were tested in an MPN suspension test with respect to Staphylococcus aureus (DSM799; initial bacterial count: 4.1E+09; incubation time: 5 minutes) at the temperatures indicated in Table 1 below. The reduction in the living cell count of the test strain is indicated in Table 1 below.

TABLE 1
Reduction in living cell count (Staphylococcus aureus)

| | 20° C. | 40° C. |
|---|---|---|
| V1 | 0.0E+0.0 | 1.0E+01 |
| V2 | 2.4E+01 | 3.0E+01 |
| V3 | 4.4E+02 | 1.0E+01 |
| V4 | 4.4E+00 | 6.0E+01 |
| E1 | >1.1E+05 | 6.0E+03 |
| E2 | 7.3E+04 | >4.5E+04 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A washing or cleaning agent comprising peroxygen-containing bleaching agent and an acylhydrazone of the general formula (I) 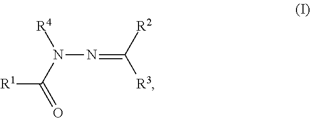
in which R¹ denotes a CF₃ group or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl, or C₃₋₁₂ cycloheteroalkyl group,
R² and R³ mutually independently denote hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, or heteroaryl group, or R2 and R3, together with the carbon atom connecting them, denote an optionally substituted 5-, 6-, 7-, 8-, or 9-membered ring that can optionally contain heteroatoms, and
R⁴ denotes hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, or an optionally substituted phenyl or naphthyl or heteroaryl group.

2. The agent according to claim 1 comprising 0.01 wt % to 5 wt % of the compound according to formula (I).

3. The agent according to claim 1, further comprising ions selected from the group consisting of manganese, titanium, cobalt, nickel, and copper.

4. A method for washing or cleaning articles wherein an agent according to claim 1 contacts said articles in an aqueous washing bath, and wherein the concentration of the compound according to formula (I) in the aqueous washing bath is 0.5 μmol/l to 500 μmol/l.

5. The method according to claim 4, characterized in that peroxygen concentration (calculated as H₂O₂) in the washing bath is in the range from 0.001 g/l to 10 g/l.

6. The agent according to claim 1, wherein the acylhydrazone corresponds to the general formula (II) 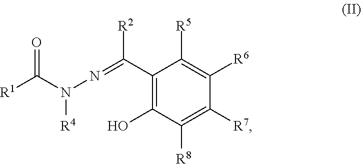
in which R¹ denotes a C₁₋₄ alkyl group that carries a substituent 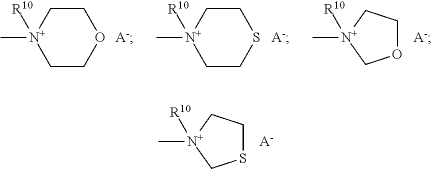
in which R¹⁰ denotes hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, and A⁻ denotes the anion of an organic or inorganic acid,
R² and R⁴ have the meaning indicated for formula (I), and
R⁵, R⁶, R⁷, and R⁸ mutually independently denote R¹, hydrogen, halogen, a hydroxy, amino, optionally substituted N-mono- or -di-C₁₋₄ alkylamino or —C₂₋₄ hydroxyalkylamino, N-phenylamino or N-naphthylamino, C₁₋₂₈ alkyl, C₁₋₂₈ alkoxy, phenoxy, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₆ heteroaralkyl, phenyl, or naphthyl group, wherein the substituents are selected from C₁₋₄ alkyl, C₁₋₄ alkoxy, hydroxy, sulfo, sulfato, halogen, cyano, nitro, carboxy, phenyl, phenoxy, naphthoxy, amino, N-mono- or -di-C₁₋₄ alkylamino or —C₂₋₄ hydroxyalkylamino, N-phenylamino, or N-naphthylamino groups, or
R⁵ and R⁶ or R⁶ and R⁷ or R⁷ and R⁸ are connected to one another forming one, two, or three carbocyclic or O-, NR¹⁰-, or S-heterocyclic, optionally aromatic and/or optionally C₁₋₆ alkyl-substituted rings.

7. The agent according to claim 1, wherein the acylhydrazone is in the form of complex compounds of central atoms of manganese, of titanium, of cobalt, of nickel, or of copper with ligands of the general formula (I).
